(19) United States
(12) Patent Application Publication
(10) Pub. No.: US 2021/0235023 A1
(43) Pub. Date: Jul. 29, 2021

(54) IMAGE-CAPTURING SUPPORT DEVICE AND IMAGE-CAPTURING SUPPORT METHOD

(71) Applicant: Konica Minolta, Inc., Tokyo (JP)

(72) Inventors: Junichi Imamura, Tokyo (JP); Keisuke Tatebayashi, Tokyo (JP)

(73) Assignee: Konica Minolta, Inc., Tokyo (JP)

(21) Appl. No.: 17/262,998

(22) PCT Filed: May 31, 2019
(86) PCT No.: PCT/JP2019/021785

§ 371 Date: Jan. 25, 2021

(30) Foreign Application Priority Data
Jul. 24, 2018 (JP) 2018-138173

(51) Int. Cl. H04N 5/232; H04N 5/33

(52) U.S. Cl. CPC H04N 5/232941; H04N 5/33; H04N 5/23229

(57) ABSTRACT

This image-capturing support device (300) includes: a display control unit (302) which generates a guidance image for guiding an operator so that a current image-capturing position and a current image-capturing direction of a camera (200) are the same as those in the past by using a previously captured image captured by the camera (200) and past position information about the camera (200) when the image has been captured, and a currently captured image and current position information about the camera (200); and a display unit (303) which displays an image including the generated guidance image.

### CROSS-REFERENCE TO RELATED APPLICATIONS

The disclosure of Japanese Patent Application No. 2018-138173, filed on Jul. 24, 2018, including the specification, drawings and abstract, is incorporated herein by reference in its entirety.

### TECHNICAL FIELD

The present invention relates to an image-capturing support apparatus and an image-capturing support method used in a gas monitoring system, for example.

### BACKGROUND ART

In the related art, a gas monitoring system configured to monitor gas leaks in a gas well of natural gas, a gas treatment plant or the like has been developed and used (for example, see Patent Literature (hereinafter, referred to as “PTL”) 1). In such a gas monitoring system, a gas leak is detected by using a monitoring camera capable of visualizing gas. As this monitoring camera, an infrared camera is generally used.

### Patent Literature

PTL 1

Japanese Patent Application Laid-Open No. 2006-030214

Incidentally, as a way for a camera to capture an image of an object set in advance for which an image-capturing is performed (hereinafter, an object for which an image-capturing is performed will be referred to as “image-capturing object”), there is a method in which a camera is fixed at a predetermined position set in advance.

On the other hand, there is another method in which an operator (which may also be referred to as “inspector”) moves and makes rounds of a site while holding a camera of a portable type, and performs an image-capturing at a point at which an image-capturing is to be performed. In the case of a gas well, a round inspection by such an operator holding and carrying a camera of a portable type is performed at a frequency of every quarter (that is, three months), for example. This method makes it possible to perform a more flexible, fine image-capturing, such as capturing an image of one object from a plurality of angles, as compared with the method in which a camera is fixed at a predetermined position set in advance. Further, since an operator actually makes rounds of a site in this method, the probability that a gas leak can be found is also considered to increase.

In this respect, for grasping the presence or absence of a gas leak, an amount of leakage, and a behavior of how leakage occurs (hereinafter, these will be referred to as “gas leakage state”), it is effective to compare a captured image captured last time with a captured image captured this time.

However, the above-described method in which an image-capturing is performed by making rounds of a site by using a camera of a portable type has disadvantages that an image-capturing point and/or an image-capturing direction are highly likely to change every round inspection, and as a result, that it becomes difficult to contrast between recorded captured images and to grasp a gas leakage state. In particular, since a gas well or a gas treatment plant is disposed within a vast site, it is extremely difficult for an operator to perform an image-capturing at the same image-capturing point and by turning a camera in the same direction as when the operator has previously performed an image-capturing. What is more, in a case where an operator of an inspection this time replaces an operator of an inspection last time, it becomes more difficult to capture an image of an image-capturing object at the same position and from the same direction as in a previous image-capturing. As a result, a change in a gas leakage state may not be accurately grasped, and the inspection quality may decrease.

### SUMMARY

One or more embodiments of the present invention provide an image-capturing support apparatus and an image-capturing support method that enable an operator utilizing an image-capturing section of a portable type to capture an image of an image-capturing object at the same position and from the same direction as in a previous image-capturing.

An image-capturing support apparatus of one or more embodiments of the present invention includes:

a guidance image generating section (i.e., processor) that generates a guidance image that guides an operator to adjust a current image-capturing position and a current image-capturing direction of an image-capturing section (i.e., image capturing device) to be identical to a previous image-capturing position and a previous image-capturing direction of the image-capturing section by using a previously captured image captured by the image-capturing section and information about a previous position of the image-capturing section when the previously captured image has been captured, and a currently captured image captured by the image-capturing section and information about a current position of the image-capturing section; and

a display that displays an image including the generated guidance image.

An image-capturing support method of one or more embodiments of the present invention includes:

storing a captured image captured by an image-capturing section in association with information about a position of the image-capturing section when the captured image has been captured;

obtaining a first comparison result by comparing information about a current position of the image-capturing section with stored information about a position of the image-capturing section, and obtaining a second comparison result by comparing a currently captured image captured by the image-capturing section with a stored captured image captured by the image-capturing section;

displaying a first guidance image for guiding the current position of the image-capturing section based on the first comparison result; and

displaying a second guidance image for guiding a current direction of the image-capturing section based on the second comparison result after displaying the first guidance image.

According to one or more embodiments of the present invention, it is possible to realize an image-capturing support apparatus and an image-capturing support method that enable an operator utilizing an image-capturing section of a portable type to capture an image of an image-capturing object at the same position and from the same direction as in a previous image-capturing.

### BRIEF DESCRIPTION OF DRAWINGS

FIG. 1 is an external view of a schematic configuration of a gas monitoring system according to one or more embodiments;

FIG. 2 is a block diagram illustrating a main configuration of the gas monitoring system of one or more embodiments;

FIG. 3 is a diagram illustrating image-capturing points and image-capturing directions in a gas well-digging area;

FIG. 4A is a diagram illustrating images displayed on a display when a camera is moved near an image-capturing point, and FIG. 4B is a diagram illustrating images displayed on the display when the camera is moved to the image-capturing point;

FIG. 5A is a diagram illustrating an example of images displayed on the display when a current image is shifted in the right direction and in the down direction with respect to a previous image, FIG. 5B is a diagram illustrating an example of images displayed on the display when a current image is shifted in the down direction with respect to a previous image, and FIG. 5C is a diagram illustrating an example of image displayed on the display when a current image is not shifted in the horizontal direction nor in the vertical direction with respect to a previous image;

FIG. 6 is a flowchart illustrating a processing procedure of an image-capturing support method executed by an image-capturing support apparatus; and

FIG. 7 is a diagram illustrating a map display of image-capturing points and image-capturing directions.

### DETAILED DESCRIPTION OF EMBODIMENTS

Hereinafter, embodiments of the present invention will he described with reference to the drawings.

### <1> Configuration

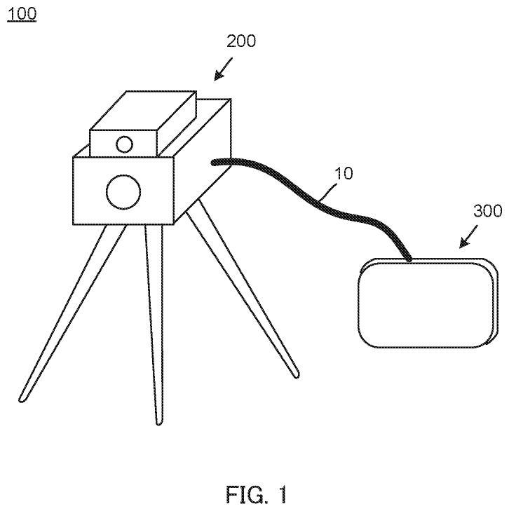

FIG. 1 is an external view of a schematic configuration of gas monitoring system 100 according to one or mote embodiments of the present invention. Gas monitoring system 100 includes a camera 200 (i.e., image capturing device) of a portable type and image-capturing support apparatus 300. Camera 200 and image-capturing support apparatus 300 are connected by cable 10. In one or more embodiments, image-capturing support apparatus 300 is embodied by a tablet-type display terminal.

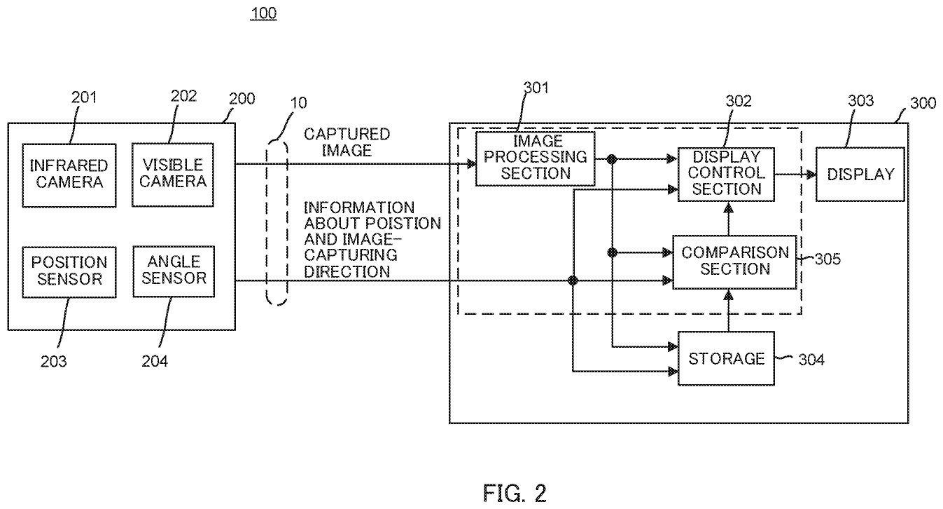

FIG. 2 is a block diagram illustrating a main configuration of gas monitoring system 100.

Camera 200 includes infrared camera 201, visible camera 202, position sensor 203, and angle sensor 204.

Infrared camera 201 obtains a captured image (infrared image) in which leaked gas is visualized. Note that, since the configuration of an infrared camera capable of visualizing gas is known, a description thereof will he omitted here. Visible camera 202 obtains a general captured image (visible image) by capturing a visible light image.

Position sensor 203 is embodied by a GPS sensor. Angle sensor 204 is embodied by an acceleration sensor. Camera 200 includes position sensor 203, thereby being capable of obtaining information about a position of the own apparatus. Further, camera 200 includes angle sensor 204, thereby being capable of obtaining information about an image-capturing direction in which the camera performs an image-capturing. Note that, a sensor other than the GPS sensor may be used as position sensor 203, and a sensor other than the acceleration sensor may be used as angle sensor 204. The point is that the position and image capturing direction of camera 200 can be obtained.

Image-capturing support apparatus 300 includes image processing section 301, display control section 302, display 303, storage 304, and comparison section 305.

Image processing section 301 forms an image in which an operator can easily recognize a location of gas leakage by inputting captured images obtained by infrared camera 201 and visible camera 202 and performing image processing on the captured images. For example, image processing section 301 forms a thermal distribution image (temperature information) based on a captured image from infrared camera 201, and extracts from the image a portion that is considered to indicate a gas outflow. Further, image processing section 301 superimposes this image of gas outflow on a captured image obtained by visible camera 202. In this way, image processing section 301 forms an image that makes it easy to understand where a gas leak occurs. Note that, what is described here is an example of image pressing performed by image processing section 301 and is not limited thereto. An image subjected to image processing by image processing section 301 is displayed on display 303 via display control section 302.

In addition, an image subjected to image processing by image processing section 301 is input to storage 304 and comparison section 305. Further, information about a position and information about an image-capturing direction, which are obtained by camera 200, are input to storage 304 and comparison section 305. Note that, instead of or in addition to an image subjected to image processing by image processing section 301, a captured image from camera 200 may be input to storage 304 and comparison section 305.

As a result, storage 304 stores a captured image that is previously captured, and information about a previous image-capturing position and a previous image-capturing direction.

Comparison section 305 compares information about a previous image-capturing position and a previous image-capturing direction, which are stored in storage 304, with information about a current image-capturing position and a current image-capturing direction of camera 200, and outputs a comparison result to display control section 302.

Display control section 302 causes display 303 to display a guidance image for guiding an operator of camera 200 to an image-capturing object based on a comparison result by comparison section 305. That is. display control section 302 functions as a guidance image generating section. Specifically, display control section 302 generates a guidance image that guides an operator such that a current image-capturing position and a current image-capturing direction of camera 200 ate identical to a previous image-capturing position and a previous image-capturing direction of camera 200, and causes display 303 to display the guidance image.

Note that, processing surrounded by a dotted line in lire figure, which is performed by image processing section 301, display control section 302 and comparison section 305, may be implemented based on a program by a computer (i.e., processor) including a central processing unit (CPU), a read only memory (ROM), and a random access memory (RAM). That is, the CPU reads a program corresponding to a processing content from the ROM, develops the program in the RAM, and performs the same processing as the processing by image processing section 301, display control section 302, and comparison section 305 described above, in cooperation with the developed program.

### <2> Operation

Next, the operation of gas monitoring system 100 of one or more embodiments will be described.

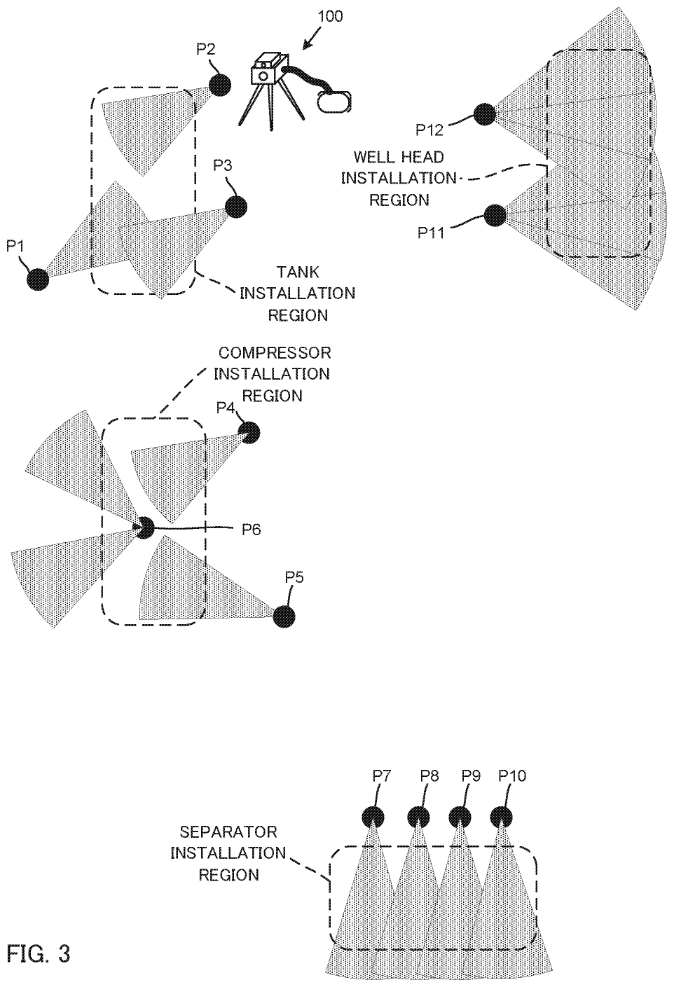

FIG. 3 is a diagram illustrating image-capturing points and image-capturing directions in a gas well-digging area. In the example of FIG. 3. there are a tank installation region, a compressor installation region, a separator installation region, and a well head installation region within the gas well-digging area. An operator moves while holding gas monitoring system 100, and captures images of an image-capturing object at image-capturing points P1 to P12 in the figure by turning camera 200 in image-capturing directions each indicated with a fan shape in the figure. Image-capturing points P1 to P12 and the image-capturing directions described above are set in advance in view of locations where a gas leak is likely to occur, and important locations. The operator captures an image of the image-capturing object at each position of image-capturing point while making rounds in the order of image-capturing points P1→P2→P3→ . . . →P10→P11→P12.

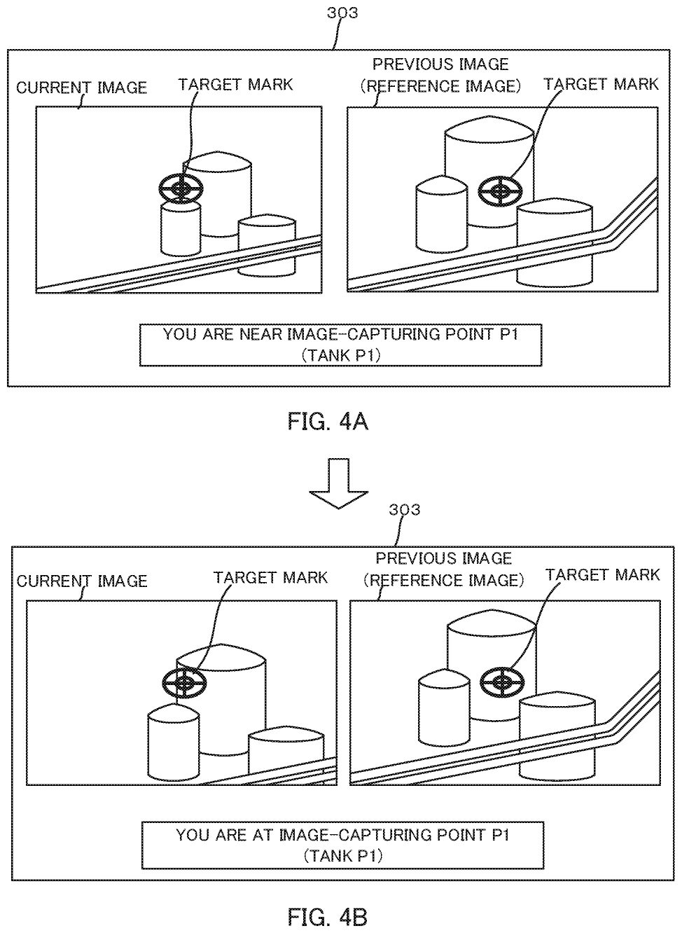

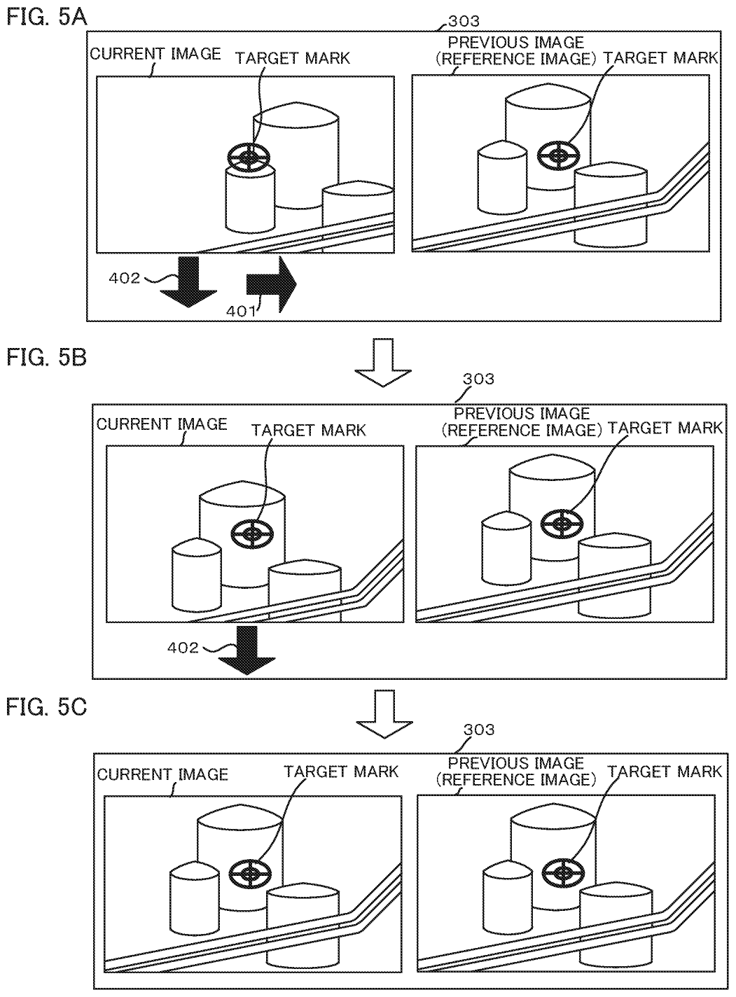

FIGS. 4 and 5 are diagrams illustrating examples of displays by display 303.

In one or more embodiments, display 303 displays a current image and a previous image. The current image is an image that is currently being captured by camera 200, and the previous image is an image stored in storage 304. The previous image may be an image captured at the time of making rounds last time, an image captured at the time of making rounds for the first time, or an image selected by an operator from previous images. The previous image serves as a reference image for a captured image this time, and can be referred to as “reference image”.

First, when an operator approaches image-capturing point P1 while carrying gas monitoring system 100, a message such as “YOU ARE NEAR IMAGE-CAPTURING POINT P1 (TANK P1)” is displayed on display 303 as illustrated in FIG. 4A, whereby the operator is capable of recognizing that camera 200 is near image-capturing point P1. Actually, such a display is performed by display control section 302 when comparison section 305 compares information about a current position of camera 200 provided by position sensor 203 with information about a position of image-capturing point P1 stored in storage 304 and a difference in the position information therebetween becomes within a predetermined range.

Next, when the above-described difference in the position information becomes almost zero, a message such as “YOU ARE AT IMAGE-CAPTURING POINT P1 (TANK P1)” is displayed on display 303 as illustrated in FIG. 4B, whereby the operator is capable of recognizing that camera 200 is disposed at image-capturing point P1.

When the operator recognizes that camera 200 is disposed at image-capturing point P1 based on a message as illustrated in FIG. 4B, the operator fixes camera 200 to a tripod or the like.

When camera 200 is fixed at a predetermined image-capturing point as described above, display 303 displays arrows 401 and 402 for guiding an image-capturing direction of camera 200 as illustrated in FIGS. 5A and 5B. FIG. 5A illustrates an example of images displayed on display 303 when a current image is shifted in the right direction and in the down direction with respect to a previous image (reference image). In this case, as illustrated in FIG. 5A, display 303 displays arrow 401 instructing the direction of camera 200 to be shifted in the right direction, and arrow 402 instructing the direction of camera 200 to he shifted in the down direction. That is, display 303 displays a shift direction of a currently captured image captured by camera 200 with respect to a captured image captured by camera 200 stored in storage 304.

This shift in an image-capturing direction may be determined by comparison section 305 (i) comparing information about an image-capturing direction provided by angle sensor 204 when a previous image (reference image) stored in storage 304 has been captured with information about a current image-capturing direction provided by angle sensor 204, or may be determined by comparison section 305 (in performing image comparison between a previous image (reference image) stored in storage 304 and a current image. Further, a shift in an image-capturing direction may be determined by both (i) and (ii). When the method (ii) is used, it is considered that a shift can be detected with better accuracy than when the method (i) is used. However, in a case where an image-capturing direction is shifted very much, a counterpart image for comparison will not exist so that the detection of a shift direction will be impossible. Accordingly, it is suitable to detect a shift in an image-capturing direction by using (i) and (ii) in combination.

Further, in one or more embodiments, an infrared image provided by infrared camera 201 and a visible image provided by visible camera 202 are obtained so that in a case where the method (ii) is performed, it is possible to detect a shift of a captured image with higher accuracy by performing image comparison between a previous image (reference image) and a current image for both the infrared image and the visible image. For example, in a case where weather conditions are bad or in a ease where an image-capturing is performed in a dark environment, it is difficult to detect a shift direction based on image comparison only with visible images. However, even in such a case, it is possible to detect a shift direction based on image comparison by using infrared images.

When the direction of camera 200 is shifted rightward by an operator from the state of FIG. 5A, the shift in the horizontal direction of the camera is eliminated and, as illustrated in FIG. 5B, arrow 401 disappears and only arrow 402 instructing live direction of camera 200 to be shifted in the down direction is displayed on display 303. Next, when the direction of camera 200 is shifted in the down direction by the operator from the state of FIG. 5B, the shift in the vertical deviation of camera 200 is eliminated and, as illustrated in FIG. 5C, no arrow instructing the direction of camera 200 to he shifted is displayed on display 303. That is, FIG. 5C is a diagram illustrating an example of images displayed on display 303 when a current image is not shifted in the horizontal direction nor in the vertical direction with respect to a previous image.

Note that, in one or more embodiments, display 303 displays a target mark in each center of a current image and a previous image as illustrated in FIGS. 4A, 4B and 5A to 5C. Thus, it is easier for an operator to capture a captured image having the same composition as a previous image by moving an image-capturing direction such that a positional relationship between a current image and its target mark is identical to a positional relationship between the previous image and its target mark.

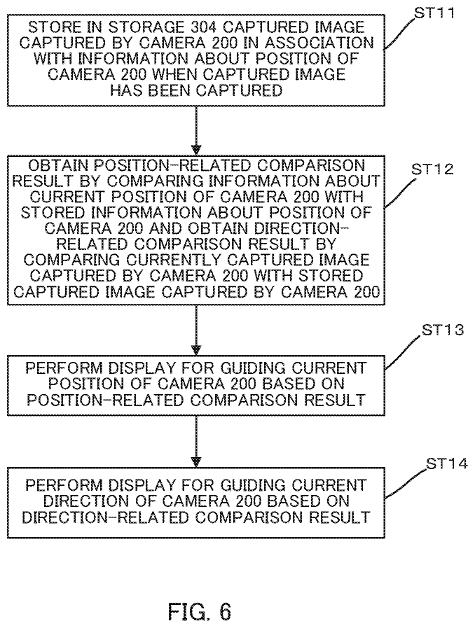

FIG. 6 is a flowchart illustrating a processing procedure of an image-capturing support method executed by image-capturing support apparatus 300.

In step ST11, image-capturing support apparatus 300 stores in storage 304 a captured image captured by camera 200 in association with information about a position of camera 200 when the captured image has been captured.

In step ST12 subsequent thereto, image-capturing support apparatus 300 obtains a position-related comparison result by comparing information about a current position of camera 200 with stored information about a position of camera 200. and obtains a direction-related comparison result by comparing a currently captured image captured by camera 200 with a stored captured image captured by camera 200. The comparisons are performed by comparison section 305.

In step ST13 subsequent thereto, image-capturing support apparatus 300 performs a display for guiding the current position of camera 200 based on the position-related comparison result.

In step ST14 subsequent thereto, image-capturing support apparatus 300 performs a display for guiding a current direction of camera 200 based on the direction-related comparison result.

In this way, the position and direction of camera 200 are guided, and camera 200 captures an image of an image-capturing object at the same position and from the same direction as in a previous image-capturing.

### <3> Effects

As described above, according to one or more embodiments, display control section 302 (which may be referred to as “guidance image generating section”) and display 303 are provided. Display control section 302 generates a guidance image that guides an operator such that a current image-capturing position and a current image-capturing direction of camera 200 are identical to a previous image-capturing position and a previous image-capturing direction of camera 200 by using a previously captured image captured by camera 200 and information about a previous position of camera 200 when the previously captured image has been captured, and a currently captured image captured by camera 200 and information about a current position of camera 200. Display 303 displays an image including the generated guidance image. Thereby, one or more embodiments make it possible to realize image-capturing support apparatus 300 enabling an operator utilizing camera 200 of a portable type to capture an image of an image-capturing object at the same position and from the same direction as in a previous image-capturing (in other words, it is possible to capture an image of an image-capturing object having the same composition at the same position as in a previous image-capturing). As a result, it is easier to contrast between recorded captured images and it is possible to grasp a change in a gas leakage state accurately.

Further, by configuring that camera 200 includes visible camera 202 and infrared camera 201 and thereby obtains a visible image and an infrared image as captured images, and that comparison section 305 compares a captured image stored in storage 304 with a currently captured image captured by camera 200 for each of the visible image and the infrared image, one or more embodiments make it possible to detect a shift of a captured image with higher accuracy and to obtain an appropriate guidance image even in a case where weather conditions are bad or in a dark environment, for example.

Further, by configuring that display 303 performs a display that guides a current position of camera 200 based on a comparison result by comparison section 305 and then performs a display that guides a current direction of camera 200 based on a comparison result by comparison section 305, one or more embodiments make it possible to capture an image of an image-capturing object smoothly at the same position and from the same direction as in a previous image-capturing.

### <4> Other Embodiments

The embodiments described above merely illustrates examples for carrying out the present invention, and the technical scope of the present invention shall not be construed as being limited thereby. That is, the present invention can be carried out in various forms without deviating from the gist or essential characteristics of the present invention.

<4-1> In the embodiments described above, a ease where a previous image, a message, a symbol, and/or the like are displayed as a guidance image for guiding an operator to an image-capturing object has been described.

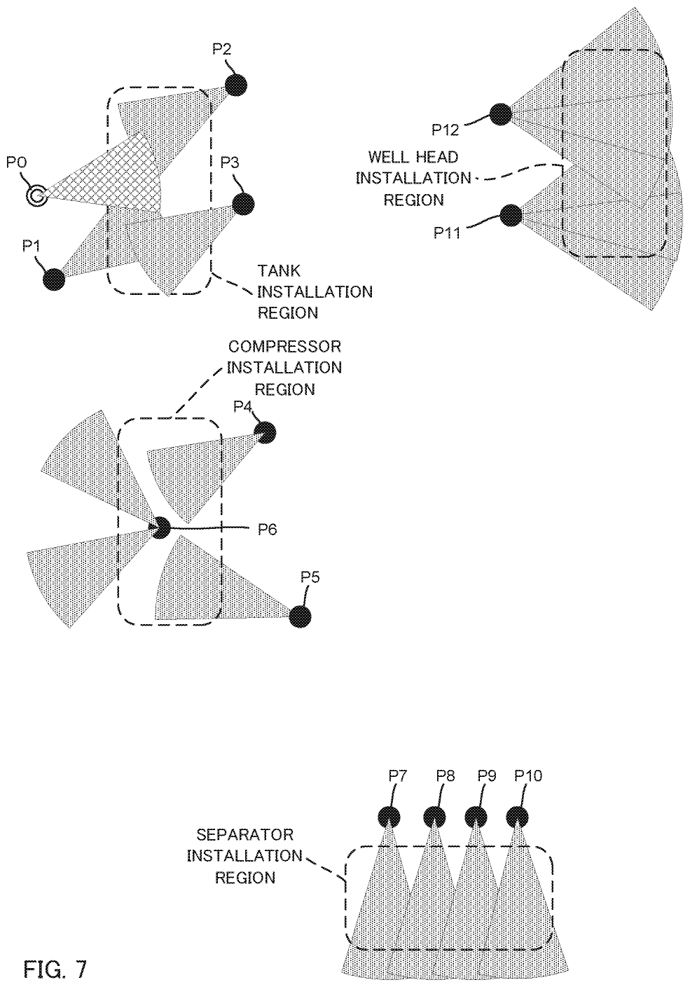

In addition thereto, image-capturing support apparatus 300 may display, for example, a map as illustrated in FIG. 7 on display 303. On the map, image-capturing points P1 to P12 at which an image-capturing is to be performed, image-capturing directions (regions having a fan shape in the figure) in which an image-capturing is to be performed, current image-capturing point P0, and a current image-capturing direction (a region having a fan shape with image-capturing point P0 as the apex in the figure) are displayed. An operator views such a map and thereby is capable of recognizing at a glance how shifted current image-capturing point P0 and the current image-capturing direction are from image-capturing points P1 to P12 at which an image-capturing is to be performed and the image-capturing directions in which an image-capturing is to be performed. The map as illustrated in FIG. 7 may be configured to be displayed, as required by an operator, by the operator operating an operation section (not illustrated) of image-capturing support apparatus 300. Thus, the operator is capable of performing rough adjustment of an image-capturing point and an image-capturing direction based on a map display as illustrated in FIG. 7. and is capable of performing fine adjustment of an image-capturing point and an image-capturing direction on the basis of a display of a message and/or a symbol based on a comparison result by comparison section 305 as in the embodiments described above. Further, when a capturing is completed, it is also possible to prevent an inspection point from missing or being mistaken, by displaying a result of the capturing on the map.

<4-2> In addition to the embodiments described above, it may be configured that image-capturing support apparatus 300 stores in storage 304 a name of an image-capturing object in association with position information, reads from storage 304 the name of the image-capturing object based on information about a current position of camera 200, and displays the name of the image-capturing object on display 303. In this way, once an operator enters a name of an image-capturing object at a certain image-capturing point, the name of the image-capturing object is thereafter read from storage 304 when camera 200 is disposed at the image-capturing point so that the operator is not required to enter the name of the image-capturing object again. A name of an image-capturing object read in this way can also be reflected in, for example, an inspection report or the like, and thereby it is possible to reduce time and effort for preparing an inspection report.

<4-3> It may be configured that a pan-tilt mechanism is provided in camera 200 and is controlled by a direction-related shift amount obtained by comparison section 305. In this way, an image-capturing direction can be adjusted automatically after camera 200 is fixed.

<4-4> In the embodiments described above, a case where storage 304 that stores a previously captured image and information about a previous position in association with each other is provided in image-capturing support apparatus 300 has been described. However, storage 304 may be provided in an apparatus different from the image-capturing support apparatus, such as a cloud server. In this case, comparison section 305 may obtain a previously captured image and information about a previous position from the outside.

<4-5> In the embodiments described above, a case where image-capturing support apparatus 300 is embodied by a tablet-type display terminal that is separate from camera 200 has been described. However, the image-capturing support apparatus of one or more embodiments of the present invention may be incorporated into camera 200.

<4-6> In the embodiments described above, a case where the image-capturing support apparatus is applied to a gas monitoring system has been described. However, the present invention is not limited to the gas monitoring system, but is widely applicable as an image-capturing support apparatus and an image-capturing support method for capturing an image of an image-capturing object at the same position and from the same direction as in a previous image-capturing, and is useful in a case where fixed point observation is performed by using a camera of a portable type.

The present invention may he applied, for example, to a gas monitoring system.

Although the disclosure has been described with respect to only a limited number of embodiments, those skill in the art, having benefit of this disclosure, will appreciate that various other embodiments may be devised without departing from the scope of the present invention. Accordingly, the scope of the invention should be limited only by the attached claims.

### REFERENCE SIGNS LIST

10 Cable
100 Gas monitoring system
200 Camera
201 Infrared camera
202 Visible camera
203 Position sensor
204 Angle sensor
300 Image-capturing support apparatus
301 Image processing section
302 Display control section
303 Display
304 Storage
305 Comparison section
401, 402 Arrow
P0 to P12 Image-capturing point

1. An image-capturing support apparatus, comprising:
a processor that generates a guidance image that guides an operator to adjust a current image-capturing position and a current image-capturing direction of an image capturing device to be identical to a previous image-capturing position and a previous image-capturing direction of the image capturing device, wherein
the guidance image is generated based on:
a previous image captured by the image capturing device and information about a previous position of the image capturing device when the previous image was captured, and
a current image captured by the image capturing device and information about a current position of the image capturing device; and
a display that displays an image including the generated guidance image.

2. The image-capturing support apparatus according to claim 1, further comprising:
a storage that stores the previous image and the information about the previous position in association with each other.

3. The image-capturing support apparatus according to claim 1, wherein the guidance image includes the previous image.

4. The image-capturing support apparatus according to claim 1, wherein the guidance image includes one or both of a message and a symbol for guiding the operator to adjust the current image-capturing position and the current image-capturing direction of the image capturing device.

5. The image-capturing support apparatus according to claim 1, wherein
the processor further compares the information about the previous position and the previous image with the information about the current position and the current image, respectively, and
the display displays, as the guidance image based on a comparison result, one or both of a message and a symbol for guiding the operator to adjust the current image-capturing position and the current image-capturing direction of the image capturing device.

6. The image-capturing support apparatus according to claim 5, wherein the display
displays the guidance image that guides the operator to adjust the current image-capturing position of the image capturing device based on the comparison result, and
then displays the guidance image that guides the operator to adjust the current image capturing direction of the image capturing device based on the comparison result.

7. The image-capturing support apparatus according to claim 5, wherein
the processor compares the information about the previous position with the information about the current position, and
when the processor obtains a comparison result indicating that a position identified by the information about the current position is within a predetermined range with respect to a position identified by the information about the previous position, the display displays the guidance image informing the operator that the comparison result is obtained.

8. The image-capturing support apparatus according to claim 5, wherein
the processor compares the previous image with the current image, and
the display displays the guidance image indicating a shift direction of the current image with respect to the previous image.

9. The image-capturing support apparatus according to claim 1, wherein the display displays, as the guidance image, an image-capturing point at which the image capturing device captures an image, on a map.

10. The image-capturing support apparatus according to claim 9, wherein the display displays, in addition to the image-capturing point, an image-capturing direction in which the image capturing device captures an image, on the map.

11. The image-capturing support apparatus according to claim 1, wherein
processor further:
stores a name of an image-capturing object in association with the information about the previous position,
reads the name of the image-capturing object corresponding to the information about the current position from the image-capturing object being stored, and
the display displays the name of the image-capturing object read by the processor.

12. The image-capturing support apparatus according to claim 1, wherein the image capturing device captures a visible image and an infrared image.

13. The image-capturing support apparatus according to claim 5, wherein
the image capturing device captures a visible image and an infrared image, and
the processor compares the previous image with the current image for each of the visible image and the infrared image.

14. An image-capturing support method, comprising:
storing an image captured by an image capturing device in association with information about a position of the image capturing device when the image was captured;
obtaining a first comparison result by comparing information about a current position of the image capturing device image with the stored information about the position of the image capturing device,
obtaining a second comparison result by comparing a current image captured by the image capturing device with the stored image captured by the image capturing device;
displaying a first guidance image for guiding the operator to adjust the current position of the image capturing device based on the first comparison result; and
after displaying the first guidance image, displaying a second guidance image for guiding the operator to adjust a current direction of the image capturing device based on the second comparison result.

15. A non-transitory computer-readable recording medium storing an image-capturing support program that causes a computer to execute processing comprising:
storing an image captured by an image capturing device in association with information about a position of the image capturing device when the image was captured;
obtaining a first comparison result by comparing information about a current position of the image capturing device with the stored information about the position of the image capturing device,
obtaining a second comparison result by comparing a current image captured by the image capturing device with the stored image captured by the image capturing device;
displaying a first guidance image for guiding the operator to adjust the current position of the image capturing device based on the first comparison result; and
after displaying the first guidance image, displaying a second guidance image for guiding the operator to adjust a current direction of the image capturing device based on the second comparison result.
